(19) United States
(12) Patent Application Publication
(10) Pub. No.: US 2026/0278592 A1
(43) Pub. Date: Sep. 17, 2026

(54) RESOURCE PROCESSING METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Wen ZOU, Shenzhen (CN)

(73) Assignee: TENCENT TECHNOLOGY (SHENZHEN) COMPANY LIMITED, Shenzhen (CN)

(21) Appl. No.: 19/683,937

(22) Filed: May 21, 2026

Related U.S. Application Data
(63) Continuation of application No. PCT/CN2025/080219, filed on Mar. 3, 2025.

(30) Foreign Application Priority Data
Apr. 7, 2024 (CN) 202410411581.1

(51) Int. Cl. G06Q 20/38

(52) U.S. Cl. CPC G06Q 20/381

(57) ABSTRACT

A resource processing method includes obtaining a first service dataset from a preset dataset, the first service dataset comprising service data, and each piece of service data being configured for recording a first historical resource transfer amount of a first resource type and a second historical resource transfer amount of a second resource type based on resources being transferred therebetween, determining, based on the second historical resource transfer amount, target service data in the at least one piece of service data that meets a resource transfer condition, determining a first resource transfer mode of the first resource type based on the first and second historical resource transfer amount in the target service data, the first resource transfer mode comprising resource transfer-in or resource transfer-out, and transferring resources of the first historical resource transfer amount of the first resource type based on the first resource transfer mode.

### CROSS-REFERENCE TO RELATED APPLICATIONS

This application is a continuation application of International Application No. PCT/CN2025/080219 filed on Mar. 3, 2025, claims priority to Chinese Patent Application No. 202410411581.1, filed with the China National Intellectual Property Administration on Apr. 7, 2024, the disclosures of each being incorporated by reference herein in their entireties.

### FIELD

The disclosure relates to the field of computer technologies, and in particular, to a resource processing method and apparatus, a device, a storage medium, and a program product.

### BACKGROUND

With the development of computer technologies, Internet-based resource circulation has emerged, bringing great convenience to people's daily lives. During international trade, a plurality of foreign exchange transaction records are generated during frequent foreign exchange transactions. During resource circulation, secondary resource transfer needs to be performed for different historical resource transfer records, to maintain a balance in resource transfer. For example, in a foreign exchange transaction, it is necessary to constantly maintain a balance between foreign exchange receipts and payments.

However, because massive resource circulation events constantly occur, in the related art, resource processing cannot be performed on the historical resource transfer records in time.

### SUMMARY

One or more embodiments provide a resource processing method and apparatus, a device, a storage medium, and a program product, to improve efficiency of resource processing and have high applicability.

One or more embodiments provide a resource processing method including: obtaining a first service dataset from a preset dataset, the first service dataset comprising at least one piece of service data, and each piece of service data being configured for recording a first historical resource transfer amount of a first resource type and a second historical resource transfer amount of a second resource type based on resources being transferred between the first resource type and the second resource type; determining, based on the second historical resource transfer amount, target service data that is in the at least one piece of service data and that meets a resource transfer condition; determining a first resource transfer mode of the first resource type based on the first historical resource transfer amount and the second historical resource transfer amount in the target service data, the first resource transfer mode comprising resource transfer-in or resource transfer-out; and transferring resources of the first historical resource transfer amount of the first resource type based on the first resource transfer mode

One or more embodiments provide a resource processing apparatus including: at least one memory configured to store computer program code; and at least one processor configured to read the program code and operate as instructed by the program code, the program code comprising: data obtaining code configured to cause at least one of the at least one processor to obtain a first service dataset from a preset dataset, the first service dataset comprising at least one piece of service data, and each piece of service data being configured for recording a first historical resource transfer amount of a first resource type and a second historical resource transfer amount of a second resource type based on resources being transferred between the first resource type and the second resource type; data analysis code configured to cause at least one of the at least one processor to determine, based on the second historical resource transfer amount, target service data that is in the at least one piece of service data and that meets a resource transfer condition; transfer mode determining code configured to cause at least one of the at least one processor to determine a first resource transfer mode of the first resource type based on the first historical resource transfer amount and the second historical resource transfer amount in the target service device, the first resource transfer mode comprising resource transfer-in or resource transfer-out; and resource transfer code configured to cause at least one of the at least one processor to transfer resources of the first historical resource transfer amount of the first resource type based on the first resource transfer mode.

One or more embodiments provide a non-transitory computer-readable storage medium, storing computer code which, when executed by at least one processor, causes the at least one processor to at least: obtain a first service dataset from a preset dataset, the first service dataset comprising at least one piece of service data, and each piece of service data being configured for recording a first historical resource transfer amount of a first resource type and a second historical resource transfer amount of a second resource type based on resources being transferred between the first resource type and the second resource type; determine, based on the second historical resource transfer amount, target service data that is in the at least one piece of service data and that meets a resource transfer condition; determine a first resource transfer mode of the first resource type based on the first historical resource transfer amount and the second historical resource transfer amount in the target service data, the first resource transfer mode comprising resource transfer-in or resource transfer-out; and transfer resources of the first historical resource transfer amount of the first resource type based on the first resource transfer mode.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a principle of a resource processing method according to one or more embodiments.

FIG. 2 is a schematic flowchart of a resource processing method according to one or more embodiments.

FIG. 3 is a schematic diagram of a data structure of a service dataset according to one or more embodiments.

FIG. 4 is a schematic diagram of another data structure of a service dataset according to one or more embodiments.

FIG. 5 is a schematic diagram of a data structure of a condition set according to one or more embodiments.

FIG. 6 is a schematic diagram of a scenario of a resource processing method according to one or more embodiments.

FIG. 7 is a schematic diagram of a scenario of changing a resource status according to one or more embodiments.

FIG. 8 is a schematic diagram of a scenario of adding a resource entry according to one or more embodiments.

FIG. 9 is a schematic diagram of a structure of a resource processing apparatus according to one or more embodiments.

FIG. 10 is a schematic diagram of a structure of an electronic device according to one or more embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

A resource processing method according to some embodiments may be applied to a related resource management platform that provides resource transfer decision-making and management, and is configured for implementing secondary transfer of a specific quantity of resources based on a historical resource circulation record between a first resource type and a second resource type in service data.

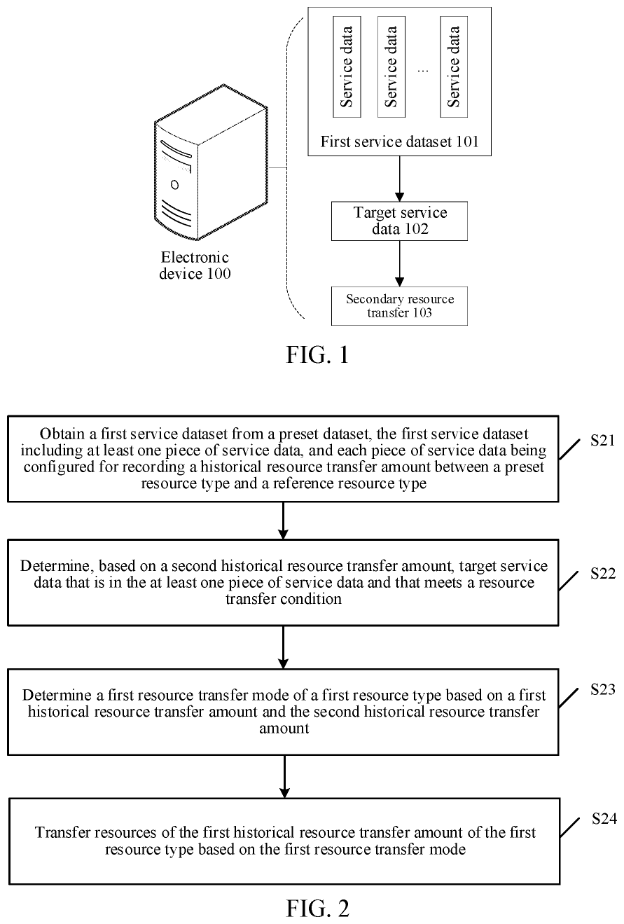

As shown in FIG. 1, after obtaining a first service dataset 101 from a large quantity of service datasets in a preset dataset, an electronic device 100 may determine a historical resource circulation record between a first resource type and a second resource type that is recorded in each piece of service data in the first service dataset 101.

Further, when it is determined, based on a second historical resource transfer amount of the second resource type, that target service data 102 that meets a resource transfer condition exists in the first service dataset 101, a first resource transfer mode of the first resource type may be determined based on a first historical resource transfer amount of the first resource type and the second historical resource transfer amount of the second resource type in the target service data 102. The first resource transfer mode includes resource transfer-in or resource transfer-out.

Based on this, for the target service data 102, secondary resource transfer 103 may be implemented based on the first resource transfer mode, that is, a specific resource quantity of resources of the first resource type in the target service data are transferred. The specific resource quantity is the first historical resource transfer amount.

The resource processing method according to some embodiments may be implemented based on the electronic device 100. The electronic device 100 may be a server or a terminal, or the electronic device 100 may be used as a corresponding functional module to implement the resource processing method according to some embodiments. Specifically, the electronic device 100 may be determined based on an actual application scenario requirement. This is not limited herein.

The server may be an independent physical server, a server cluster or a distributed system including a plurality of physical servers, or a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The terminal may be a smartphone, a tablet computer, a notebook computer, a desktop computer, a smart speaker, a smartwatch, an in-vehicle terminal, an aircraft, a smart household appliance (for example, a smart television), a wearable device, or the like.

Referring to FIG. 2, FIG. 2 is a schematic flowchart of a resource processing method according to one or more embodiments. As shown in FIG. 2, the resource processing method according to some embodiments is performed by an electronic device, for example, the electronic device 100 in FIG. 1, and may include the following operations.

S21: Obtain a first service dataset from a preset dataset, the first service dataset including at least one piece of service data, and each piece of service data being configured for recording a historical resource transfer amount between a first resource type and a second resource type.

In some embodiments, the preset dataset includes at least one service dataset, each service dataset includes at least one piece of service data, and each piece of service data is configured for recording a first historical resource transfer amount of the first resource type and a second historical resource transfer amount of the second resource type when resources are transferred between the first resource type and the second resource type.

The resource type refers to a type or classification of a resource, and is configured for classifying and counting resource quantities through different dimensions.

The second resource type may also be referred to as a basic resource type, playing a central role in resource transfer, resource measurement, resource counting, and resource management.

The first resource type is a resource type that may be configured for classifying and counting resource quantities in resource transfer, resource measurement, resource counting, and resource management.

In an example, in a foreign exchange transaction scenario, CNY is the second resource type, and EUR and HKD are respectively the first resource types in different countries or regions and serve as a measure of value and a medium of exchange. In this case, CNY may be used as a basic resource type, and EUR and HKD may be used as different first resource types.

The foreign exchange transaction refers to buying resources of one resource type in a pair of resource type combination (for example, CNY and EUR) and selling resources of the other resource type, which is an exchange of resource quantities between the first resource type and the second resource type.

For each piece of service data, the service data is configured for recording the historical resource transfer amount between the first resource type and the second resource type, and is specifically configured for recording a historical resource transfer-out amount and a historical resource transfer-in amount of the first resource type and the second resource type when a resource transfer (that is, exchange) occurs between the first resource type and the second resource type.

Specifically, for each piece of service data, the service data is configured for recording a first historical resource transfer-in amount of the first resource type and a second historical resource transfer-out amount of the second resource type, or is configured for recording a first historical resource transfer-out amount of the first resource type and a second historical resource transfer-in amount of the second resource type.

In other words, for each piece of service data, the service data is configured for recording a quantity of resources of the second resource type that are transferred out when a specific quantity of resources of the first resource type are transferred in, or is configured for recording a quantity of resources of the second resource type that are transferred in when a specific quantity of resources of the first resource type are transferred out.

In an example, in a foreign exchange transaction scenario, the first service dataset may be referred to as a position set, and each piece of service data in the position set is configured for recording a buy and sell amount between the first resource type and the second resource type.

The first service dataset may be shown in FIG. 3. A service dataset (for example, the first service dataset) is also referred to as a position set, and each position in the position set may be considered as one piece of service data.

The position set may also be referred to as an exposure set, which is configured for recording foreign exchange exposure.

The position includes a “long position” and a “short position”. The long position represents that a buying amount is greater than a selling amount, and the short position represents that a selling amount is greater than a buying amount. The “short position” and the “long position” may also be referred to as the “foreign exchange exposure”.

As shown in FIG. 3, for service data A, the service data A is configured for recording that 66895 CNY is sold when 10000 USD is bought. For service data B, the service data B is configured for recording that 133990 CNY is bought when 20000 EUR is sold. For service data C, the service data C is configured for recording that 9000 CNY is sold when 10000 HKD is bought. For service data D, the service data D is configured for recording that 70000 CNY is sold when 10000 EUR is bought.

CNY, USD, EUR, and HKD represent different resource types, CNY is the second resource type, and USD, EUR, and HKD are different first resource types.

A negative sign “−” included in a value of the historical resource transfer amount represents that the historical resource transfer amount is the historical resource transfer-out amount, for example, a second historical resource transfer amount −66895 in the service data A, and a first historical resource transfer amount −20000 in the service data B. In some embodiments, the first historical resource transfer amount and the second historical resource transfer amount both refer to absolute values.

S22: Determine, based on the second historical resource transfer amount, target service data that is in the at least one piece of service data and that meets a resource transfer condition.

In some embodiments, after the first service dataset is obtained, whether the target service data that meets the resource transfer condition exists in the first service dataset may be determined based on the second historical resource transfer amount of the second resource type recorded in each piece of service data in the first service dataset.

Specifically, a first condition set associated with the first service dataset may be first obtained.

The service datasets in the preset dataset are respectively associated with different condition sets, or the service datasets in the preset dataset may be associated with the same condition set, which may be specifically determined based on an actual application scenario requirement. This is not limited herein.

The condition set associated with each service dataset includes at least one trigger condition, and each trigger condition is configured for determining whether each piece of service data in the service dataset meets the resource transfer condition.

For example, the first service dataset includes at least one trigger condition, and each trigger condition includes a resource quantity threshold.

For any service dataset, if the second historical resource transfer amount of the second resource type in a piece of service data of the service dataset exceeds a resource quantity threshold corresponding to any trigger condition in a corresponding condition set, it indicates that the service data may be used as candidate service data that may meet the resource transfer condition, and further, the target service data that meets the resource transfer condition is determined from the pieces of candidate service data.

For the first service dataset, after the first condition set associated with the first service dataset is obtained, if at least one piece of candidate service data in which second historical resource transfer amount exceeds at least one of the resource quantity thresholds (that is, a resource quantity threshold corresponding to at least one trigger condition) in the first condition set exists in the first service dataset, the target service data that meets the resource transfer condition may be determined based on the pieces of candidate service data.

In other words, after the first condition set associated with the first service dataset is obtained, each piece of service data in the first service dataset may be compared with each trigger condition in the first condition set one by one, to determine, from the first service dataset, the candidate service data in which second historical resource transfer amount exceeds the resource quantity threshold corresponding to the at least one trigger condition.

Further, after the candidate service data is determined from the first service dataset, the target service data that meets the resource transfer condition may be determined based on the pieces of candidate service data.

In some embodiments, each trigger condition further includes a resource type range and a valid time interval.

In this case, when the target service data is determined based on the candidate service data, for each piece of candidate service data,
in the at least one trigger condition, a trigger condition in which the resource quantity threshold does not exceed the second historical resource transfer amount in the candidate service data is determined as a candidate trigger condition; and
the candidate service data is determined as the target service data in response to a current moment being within the valid time interval included in any candidate trigger condition, and the resource type range included in the any candidate trigger condition including the first resource type in the candidate service data.

In an example, in a foreign exchange transaction scenario, if CNY is the second resource type, USD is the first resource type. After a user 1 exchanges CNY for USD, service data E may be generated. The service data E is configured for recording that the user 1 spends 1000 CNY (that is, the second historical resource transfer-out amount) to exchange for 10 USD (that is, the first historical resource transfer-in amount). After a user 2 exchanges USD for CNY, service data F may be generated. The service data F is configured for recording that the user 2 exchanges 1 USD (that is, the first historical resource transfer-out amount) for 10 CNY (that is, the second historical resource transfer-in amount).

If the service data E and the service data F belong to the first service dataset, and the first service dataset includes a trigger condition A, a resource quantity threshold included in the trigger condition A is 800. For the service data E, because an amount of CNY spent by the user 1 is 1000, which exceeds 800, the service data E may be determined as the candidate service data. For the service data F, because an amount of CNY exchanged by the user 2 is 10, which does not exceed 800, it is determined that the service data F is not the candidate service data.

When the trigger condition A includes only the resource quantity threshold, the service data E may be determined as the target service data that meets the resource transfer condition.

When the trigger condition A further includes the resource type range and the valid time interval, and the current moment is within the valid time interval corresponding to the trigger condition A, if the resource type range corresponding to the trigger condition A includes USD, it may be determined that the service data E is the target service data, and if the resource type range corresponding to the trigger condition A does not include USD, it is determined that the service data E is not the target service data.

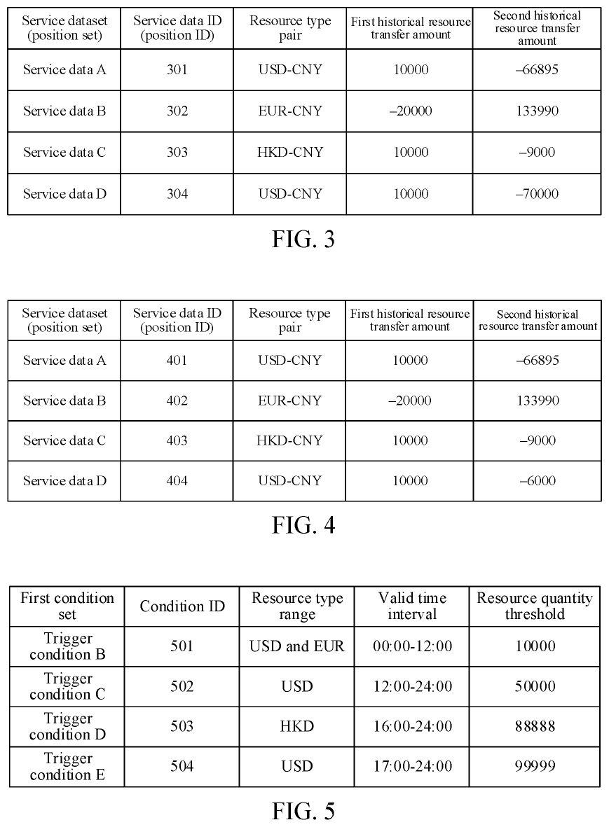

In an example, in a foreign exchange transaction scenario, the first service dataset may be shown in FIG. 4, and the first condition set associated with the first service dataset may be shown in FIG. 5.

CNY, USD, EUR, and HKD represent different resource types, CNY is the second resource type, and USD, EUR, and HKD are different first resource types.

It can be known with reference to FIG. 4 and FIG. 5 that when the service data A is the candidate service data, the second historical resource transfer amount transferred out by the service data A is 66895, which exceeds resource quantity thresholds 10000 and 50000 corresponding to a trigger condition B and a trigger condition C, and therefore, the trigger condition B and the trigger condition C are determined as candidate trigger conditions corresponding to the service data A.

Further, if the current moment is 1: 00, the current moment is within the valid time interval corresponding to the trigger condition B, and the first resource type (USD) in the service data A is within the resource type range corresponding to the trigger condition B, so that the service data A can be determined as the target service data.

When the service data B is the candidate service data, the second historical resource transfer amount transferred in by the service data B is 133990, which exceeds respective resource quantity thresholds corresponding to the trigger condition B to the trigger condition E, that is, 10000, 50000, 88888, and 99999. Therefore, the trigger condition B to the trigger condition E are all determined as candidate trigger conditions corresponding to the service data B.

Further, when the current moment is 1: 00, the current moment is only within the valid time interval corresponding to the trigger condition B (00: 00-12: 00), and the first resource type (EUR) in the service data B is within the resource type range (USD and EUR) corresponding to the trigger condition B, so that the service data B can be determined as the target service data.

In FIG. 4, for the service data C and the service data D, the second historical resource transfer amounts transferred out by the service data C and the service data D are respectively 9000 and 6000, which are less than the resource quantity thresholds corresponding to the trigger conditions in FIG. 5, that is, 10000, 50000, 88888, and 99999. Therefore, it is determined that the service data C and the service data D are not the target service data.

S23: Determine a first resource transfer mode of the first resource type based on the first historical resource transfer amount and the second historical resource transfer amount.

After the target service data is determined from the first service dataset, the first resource transfer mode of the first resource type in the target service may be determined based on the historical resource transfer amount between the first resource type and the second resource type in the target service data.

Specifically, the first resource transfer mode includes resource transfer-in or resource transfer-out.

Specifically, if the first historical resource transfer amount of the first resource type in the target service data is a first historical resource transfer-out amount, and the second historical resource transfer amount of the second resource type in the target service data is a second historical resource transfer-in amount, it is determined that the first resource transfer mode of the first resource type is the resource transfer-in.

In other words, for the target service data, when a specific quantity of resources of the second resource type are obtained by transferring out a specific quantity of resources of the first resource type previously, a specific quantity of resources of the first resource type are subsequently transferred in when the target service data meets the resource transfer condition.

If the first historical resource transfer amount of the first resource type in the target service data is a first historical resource transfer-in amount, and the second historical resource transfer amount of the second resource type in the target service data is a second historical resource transfer-out amount, it is determined that the first resource transfer mode of the first resource type is the resource transfer-out.

In other words, for the target service data, when a specific quantity of resources of the first resource type are obtained by transferring out a specific quantity of resources of the second resource type previously, a specific quantity of resources of the first resource type are subsequently transferred in when the target service data meets the resource transfer condition.

S24: Transfer resources of the first historical resource transfer amount of the first resource type based on the first resource transfer mode.

In this operation, performing new secondary transfer includes: When it is determined that the first resource transfer mode of the first resource type is the resource transfer-in, resources of the first historical resource transfer-out amount of the first resource type may be transferred into a virtual account corresponding to the first resource type. When it is determined that the first resource transfer mode of the first resource type is the resource transfer-out, resources of the first historical resource transfer-in amount of the first resource type may be transferred out of a virtual account corresponding to the first resource type.

In some embodiments, after the first service dataset is obtained, for each piece of service data configured for recording the historical resource transfer amount between the first resource type and the second resource type, the target service data that meets the resource transfer condition may be determined in time based on the second historical resource transfer amount of the second resource type, thereby improving efficiency of determining the target service data. Further, a resource transfer mode for performing resource transfer for the first resource type and a to-be-transferred resource quantity may be determined based on the historical resource transfer amount recorded in the target service data, so that the resource quantity of the first resource type may be directly transferred based on the determined resource transfer mode. In this way, efficiency of resource processing is improved and applicability is high while a balance between the resource quantity of the first resource type and the resource quantity of the second resource type in the target service is achieved.

In some embodiments, after the first resource transfer mode is determined, a second resource transfer mode for the second resource type may be determined.

The first resource transfer mode is opposite to the second resource transfer mode. For example, when the first resource transfer mode is the resource transfer-in, the second resource transfer mode is the resource transfer-out; and when the first resource transfer mode is the resource transfer-out, the second resource transfer mode is the resource transfer-in.

Further, because when the resources of the first resource type are transferred in, a specific quantity of resources of the second resource type need to be transferred out, or when the resources of the first resource type are transferred out, a specific quantity of resources of the second resource type also need to be transferred in, a resource conversion rate between the first resource type and the second resource type in the target service data may be first determined. For example, an exchange rate between CNY and USD in a foreign exchange transaction scenario is determined.

In this case, a current resource transfer amount corresponding to the second resource type may be determined based on the first historical resource transfer amount and the resource conversion rate. Further, when the resources of the first historical resource transfer amount of the first resource type are transferred based on the first resource transfer mode, resources of the current resource transfer amount of the second resource type may be transferred based on the second resource transfer mode. For example, when the resources of the first historical resource transfer amount are transferred into the virtual account corresponding to the first resource type, resources of the current resource transfer amount are transferred out of a virtual account corresponding to the second resource type. Conversely, when the resources of the first historical resource transfer amount are transferred out of the virtual account corresponding to the first resource type, the resources of the current resource transfer amount are transferred into the virtual account corresponding to the second resource type.

For example, in a foreign exchange transaction scenario, the exposure involves an imbalance between receipts and payments. Coupled with exchange rate fluctuations, this may lead to risks. Therefore, it is necessary to sell long positions and cover short positions, that is, to close the position or square the exposure. If a position (service data) meets the resource transfer condition, in this case, it may be determined to close the position for the virtual foreign currency (corresponding to the first resource type) in the position. In other words, in the service data, when a specific amount of virtual foreign currency is bought previously, in this case, the same amount of virtual foreign currency needs to be sold; and when a specific amount of virtual foreign currency is sold previously, in this case, the same amount of virtual foreign currency needs to be bought.

In an example, referring to FIG. 3, for the service data A, the service data A is configured for recording that 66895 CNY is sold when 10000 USD is bought. When the service data A is the target service data that meets the resource transfer condition, because the first historical resource transfer mount of the first resource type (that is, USD) in the service data A is the first historical resource transfer-in amount (that is, 10000), and the second historical resource transfer amount of the second resource type (that is, CNY) is the second historical resource transfer-out amount (that is, 66895), in this case, it may be determined that the first resource transfer mode for the first resource type (that is, USD) in the service data A is the resource transfer-out, and 10000 USD is then transferred out of a virtual account corresponding to USD. In addition, a current resource transfer amount corresponding to CNY is determined based on 10000 USD and a current exchange rate between USD and CNY, and the current resource transfer amount of CNY is then transferred into a virtual account corresponding to CNY.

In another example, referring to FIG. 3, for the service data B, the service data B is configured for recording that 133990 CNY is bought when 20000 EUR is sold. When the service data B is the target service data that meets the resource transfer condition, because the first historical resource transfer amount of the first resource type (that is, EUR) in the service data B is the first historical resource transfer-out amount (that is, 20000), and the second historical resource transfer amount of the second resource type (that is, CNY) is the second historical resource transfer-in amount (that is, 133990), in this case, it may be determined that the first resource transfer mode for the first resource type (EUR) in the service data B is the resource transfer-in, and 20000 EUR is then transferred into a virtual account corresponding to EUR. In addition, a current resource transfer amount corresponding to CNY is determined based on the 20000 EUR and a current exchange rate between EUR and CNY, and the current resource transfer amount of CNY is then transferred out of the virtual account corresponding to the CNY.

In some embodiments, the service data is classified into different service datasets, and classification and management may be performed on the service data according to different service requirements of the service. Because the trigger conditions in the first condition set are configured for limiting ranges, valid time intervals, and resource quantity thresholds of different first resource types, all the target service data that meets the resource transfer condition in the first service dataset may be quickly determined in a targeted manner based on the trigger conditions in the first condition set. This is beneficial to improving timeliness of resource quantity transfer.

In addition, when the first historical resource transfer amount of the first resource type in the target service data is the historical resource transfer-in amount, the same resource quantity of resources of the first resource type may be transferred out. When the first historical resource transfer amount of the first resource type in the target service data is the historical resource transfer-out amount, the same resource quantity of resources of the first resource type may be transferred in. This is beneficial to maintaining resource quantity balance of the first resource type in time, and can improve efficiency of resource processing.

In some embodiments, the service datasets in the preset dataset may be determined in a classification manner.

Specifically, a plurality of pieces of service data may be obtained.

The service data may be obtained from different service data processing platforms, accounts, and the like. A specific obtaining manner is not limited herein.

Further, after the plurality of pieces of service data are obtained, the pieces of service data may be classified based on at least one of a transfer time of a historical resource quantity, a resource type, or a source of the service data, to obtain at least one service dataset.

The transfer time of the historical resource quantity includes a generation time of the first historical resource transfer amount of the first resource type and a generation time of the second historical resource transfer amount of the second resource type that are recorded in the service data.

In an example, the generation time of the first historical resource transfer amount and the generation time of the second historical resource transfer amount may be the same. In this case, the transfer time of the historical resource transfer amount is a single value, and service data whose transfer time is within the same preset interval may be classified into one service dataset.

In an example, when the service data is classified based on the first resource type, service data of the same first resource type may be classified into one service dataset, or service data of the same second resource type may be classified into one service dataset, or service data related to the same resource type pair (that is, both the first resource type and the second resource type are the same) may be classified into one service dataset.

The source of the service data may be different resource management platforms, resource processing channels, accounts, geographical regions, and the like, and may be specifically determined based on an actual application scenario requirement. This is not limited herein.

In some embodiments, each service dataset and a corresponding condition set may be jointly stored in the preset dataset in an associated manner. When the first service data and the first condition set associated with the first service data are obtained, any resource entry in a resource pool that is in an unlocked state may be determined as a target resource entry, and the target resource entry is set to be in a locked state.

The resource pool includes at least one resource entry, where each resource entry includes a dataset identifier of a service dataset in the preset dataset and a condition set identifier of a condition set associated with the service dataset.

A resource status of each resource entry in the resource pool is a locked state or an unlocked state. For each resource entry in the resource pool, if the resource entry is in the locked state, it indicates that the resource entry is in an unavailable state in the resource pool; or if the resource entry is in the unlocked state, it indicates that the resource entry is in an available state in the resource pool.

Further, a service dataset in the preset dataset that corresponds to the dataset identifier in the target resource entry may be determined as the first service dataset, and a condition set in the preset dataset that corresponds to the condition set identifier in the target resource entry may be determined as the first condition set associated with the first service dataset.

Based on this, the first service dataset and the first condition set associated with the first service dataset may be obtained from the preset dataset based on the target resource entry.

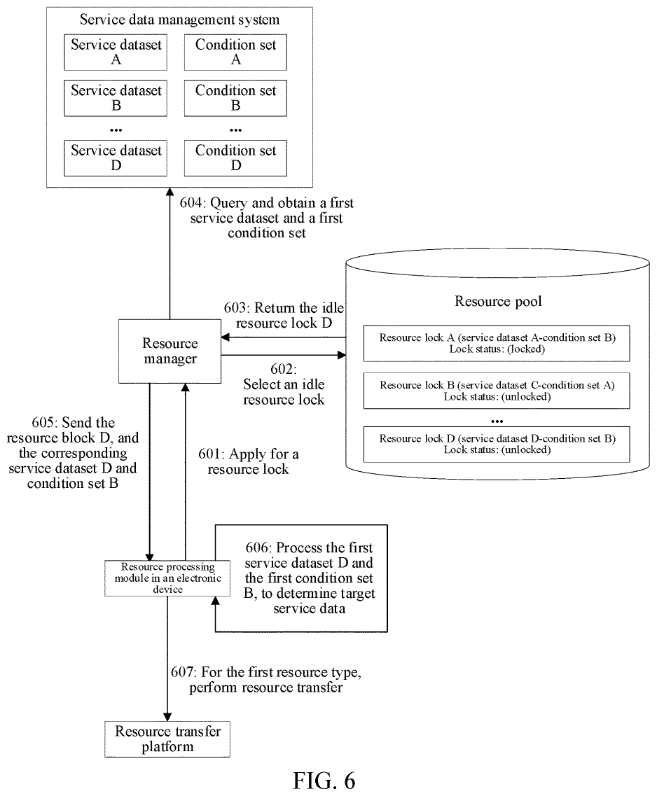

As shown in FIG. 6, FIG. 6 is a schematic diagram of a scenario of a resource processing method according to one or more embodiments. The resource processing method shown in FIG. 6 may be performed by a resource processing module in an electronic device.

Operation 601: Apply for a resource lock (that is, a resource entry) from a resource manager, to obtain first service data and a first condition set associated with the first service data.

Operation 602: Select an idle resource lock in a resource pool through the resource manager. In other words, a target resource entry in an unlocked state is selected in the resource pool through the resource manager.

For example, the resource pool includes a plurality of resource locks such as a resource lock A, a resource lock B, and a resource lock C. Each resource lock may be considered as one resource entry. Each resource lock includes a dataset identifier of one service dataset and a condition set identifier of a condition set associated with the service dataset. For example, the resource lock A corresponds to a resource entry, which includes a service dataset identifier: service dataset A, and a condition set identifier: condition set B.

The resource pool can run in a relational database, and the resource manager is configured to perform operations such as adding of the resource lock in the resource pool, setting of the locked state or the unlocked state, and transferring of the resource lock.

To enable the resource lock in the resource pool to be obtained at a high frequency and enable a corresponding service dataset and an associated condition set thereof to be run repeatedly, a preemption time may be preset for each resource lock in the resource pool, and each resource lock can only be obtained once within its respective preemption time. In some embodiments, when the status of the resource lock is set from the locked state to the unlocked state through the resource manager, the status of the resource lock may be changed after a delay time. For example, when the status of the resource lock A needs to be set from the locked state to the unlocked state, the resource lock A may be set to be in the unlocked state after a preset delay time, to avoid that the resource lock A is repeatedly obtained in a short time.

Operation 603: The resource pool returns a resource lock (for example, a resource lock D) that is in an idle state (that is, in the unlocked state) to the resource manager.

Operation 604: The resource manager queries and obtains a first service dataset and a first condition set that correspond to the idle resource lock from a preset dataset in a service data management system. For example, a service dataset D and a condition set B that correspond to the resource lock D are queried and obtained from the service data management system.

Operation 605: The resource manager sends the resource lock D, and the obtained first service dataset D and first condition set B to the resource processing module.

Operation 606: The resource processing module processes the first service dataset D and the first condition set B, that is, matches each trigger condition in the first condition set B with each piece of service data in the first service dataset D, to determine target service data that meets a resource transfer condition from the first service dataset D. For a specific process, refer to the foregoing embodiment.

Operation 607: The resource processing module performs resource transfer for a first resource type in the target service data.

If a first historical resource transfer amount of the first resource type in the target service data is a first historical resource transfer-in amount, resources of the first resource type equivalent to the first historical resource transfer-in amount are transferred out of a virtual account corresponding to the first resource type through a resource transfer platform.

If the first historical resource transfer amount of the first resource type in the target service data is a first historical resource transfer-out amount, resources of the first resource type equivalent to the first historical resource transfer-out amount are transferred into the virtual account corresponding to the first resource type through the resource transfer platform.

In a foreign exchange transaction scenario, the service data management system may be an exposure management system, which is a system configured to aggregate all foreign exchange exposures, and then perform exposure management according to a policy. The policy includes: a plurality of square moments, routing to different banking channels for squaring, and a volume of squaring transactions.

In the foreign exchange transaction scenario, the resource processing module may also be referred to as an automatic position closing module, and may include a submodule 1 that communicates with the resource manager, a submodule 2 that is responsible for matching the first service dataset with the first condition set, a submodule 3 that communicates with the resource transfer platform to be responsible for resource quantity transfer, and the like.

In the method shown in FIG. 6, different resource locks in the unlocked state may be simultaneously applied for through a plurality of resource processing modules, thereby improving efficiency of the resource quantity transfer.

Each time after applying for a resource lock in the unlocked state and completing resource transfer, the resource processing module may apply for a resource lock in the unlocked state after a time interval, to perform resource transfer again.

The time interval may be dynamically adjusted based on a quantity of the resource locks and a quantity of the resource processing modules. For example, a time interval when the quantity of the resource processing modules exceeds the quantity of the resource locks is compared with a time interval when the quantity of the resource processing modules does not exceed the quantity of the resource locks, thereby saving calculation resources, and improving efficiency of resource processing.

In some embodiments, after the target resource entry is obtained from the resource pool and is set to be in the locked state, if resource transfer of the first historical resource transfer amount is completed based on a first resource transfer mode, the target resource entry is set to be in the unlocked state again.

In some embodiments, to avoid that the target resource entry is in the locked state in an extended period due to a data processing exception, after the target resource entry is obtained from the resource pool, if the resource transfer of the first historical resource transfer amount is completed based on the first resource transfer mode within a preset duration after the target resource entry is set to be in the locked state, the target resource entry is set to be in the unlocked state again.

If the resource transfer of the first historical resource transfer amount is not completed based on the first resource transfer mode within a preset duration after the target resource entry is set to be in the locked state, it indicates that resource processing expires. In this case, the resource transfer is terminated, and the target resource entry is set to be in the unlocked state again.

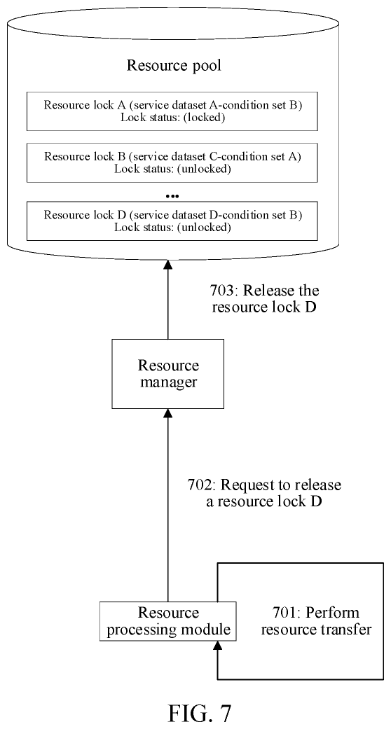

In an example, referring to FIG. 7, FIG. 7 is a schematic diagram of a scenario of changing a resource status according to one or more embodiments. If in the manner shown in FIG. 6, after the resource lock D (that is, the target resource entry) is obtained from the resource pool, the resource lock D (the target resource entry) in the resource pool is set to be in the locked state.

Operation 701: That the resource processing module performs resource transfer includes at least one of the following three cases:
completing the resource transfer of the first historical resource transfer amount of the first resource type based on the determined first resource transfer mode; or
completing the resource transfer of the first historical resource transfer amount of the first resource type based on the first resource transfer mode within the preset duration after the resource lock D is set to be in the locked state; or
skipping completing the resource transfer of the first historical resource transfer amount of the first resource type based on the first resource transfer mode within the preset duration after the resource lock D is set to be in the locked state.

Operation 702: The resource processing module requests the resource manager to release the resource lock D, that is, requests to change the lock status of the resource lock D from the locked state to the unlocked state.

Operation 703: The resource manager requests the resource pool to release the resource lock D, so that the lock status of the resource lock D in the resource pool is changed from the locked state to the unlocked state.

In some embodiments, after the resource transfer of the first historical resource transfer amount of the first resource type is completed based on the first resource transfer mode, the target resource entry may be obtained again from the resource pool after a first time interval.

If all the resource entries in the resource pool are in the locked state after the first time interval, the target resource entry is obtained again from the resource pool after a second time interval. The second time interval is less than the first time interval.

In some embodiments, the resource entries in the resource pool may be determined based on the following manner:
for service data in each service dataset of the preset dataset,
generating a condition set associated with the service dataset;
generating a resource entry of the service dataset based on the dataset identifier of the service dataset and the condition set identifier of the generated condition set; and
adding each resource entry to the resource pool, and setting each resource entry to be in the unlocked state.

In other words, after the service dataset is added to the preset dataset, for each service dataset, a trigger condition applicable to each piece of service data may be generated based on the historical resource transfer amount, the first resource type, and the like that are recorded in each piece of service data in the service dataset, to obtain the condition set associated with the service dataset.

The trigger condition corresponding to each piece of service data may be specifically determined based on an actual application scenario requirement. This is not limited herein.

Further, after the service dataset and the condition set associated with each service dataset are added to the preset dataset, for each service dataset, a resource entry corresponding to the service dataset may be generated based on the dataset identifier of the service dataset and the condition set identifier of the condition set associated with the service dataset. In this case, each resource entry may be added to the resource pool.

In some embodiments, each time after a resource entry is generated and added to the resource pool, the resource entry may be set to be in the unlocked state, so that when the target resource entry is obtained, the resource entry is in a selectable range.

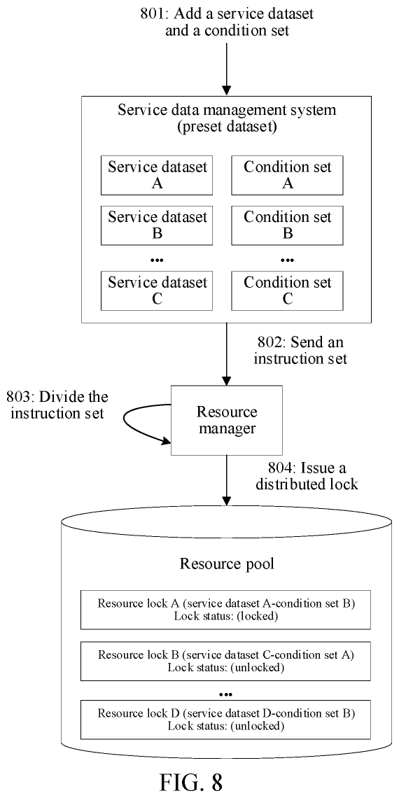

Referring to FIG. 8, FIG. 8 is a schematic diagram of a scenario of adding a resource entry according to one or more embodiments. As shown in FIG. 8, the following operations are included.

Operation 801: After the service dataset and the condition set associated with each service dataset are determined, each service dataset and each condition set may be added to the preset dataset of the service data management system, and a plurality of resource entries may be generated.

Operation 802: The service data management system sends an instruction set to the resource manager, and the instruction set is configured for requesting the resource manager to add a resource entry to the resource pool.

The instruction set includes each resource entry, where each resource entry includes a dataset identifier of a service dataset and a condition set identifier of a condition set associated with the service dataset.

For example, the instruction set may be represented as: (“service dataset A, condition set B”, “service dataset C, condition set A”, . . . , and “service dataset D, condition set B”).

Operation 803: The resource manager may divide the instruction set, to obtain resource entries, for example, obtain the resource entry configured for indicating that the service dataset A is associated with the condition set B (service dataset A, condition set B), the resource entry configured for indicating that the service dataset C is associated with the condition set A (service dataset C, condition set A), and the resource entry configured for indicating that the service dataset D is associated with the condition set B (service dataset D, condition set B).

Operation 804: The resource manager may issue a distributed lock in the resource pool, to add each resource entry, as a resource lock, to the resource pool, and set an initial status of each resource lock to be in the unlocked state.

Based on the foregoing implementation, a plurality of target resource entries may be simultaneously obtained from the resource pool, and resource processing is performed in parallel on service data corresponding to the plurality of target resource entries.

In some embodiments, each service dataset may be associated with a plurality of condition sets, which may be specifically determined based on an actual application scenario requirement. This is not limited herein.

For example, a service dataset H may be associated with a condition set N and a condition set M. The condition set N is configured for determining target service data from the service dataset H on holidays, and the condition set M is configured for determining target service data from the service dataset H on workdays.

In some embodiments, in the resource processing process, each time after a target resource entry is obtained from the resource pool, the target resource entry may be set to be in the locked state, to avoid performing repeated resource processing on service data corresponding to the target resource entry. This is beneficial to improving efficiency of resource processing. In addition, the resource pool may support parallel obtaining of the plurality of target resource entries and parallel resource processing, which is beneficial to further improving efficiency of resource processing.

In some embodiments, to improve a speed of determining the target service data, the first service dataset and the associated first condition set may be inputted into a condition determining model, to determine the target service data that meets the resource transfer condition from the first service dataset and the associated first condition set.

The foregoing condition determining model may be obtained through training based on technologies such as artificial intelligence (AI)-based machine learning (ML), cloud computing in a cloud technology, and an artificial intelligence cloud service.

The resource transfer amount counting and resource processing process involved in some embodiments may be implemented based on the cloud computing in the cloud technology.

The preset dataset (including the service dataset and the condition set) in some embodiments may be stored in a specified storage space. The specified storage space includes, but is not limited to, cloud storage, a database (such as a relational database or a non-relational database), a blockchain, or the like, which may be determined based on an actual application scenario requirement. This is not limited herein.

The cloud storage refers to the practice of integrating a large quantity of storage devices (also referred to as storage nodes) of different types in a network together through application software or an application interface to work collaboratively, to jointly store the preset dataset (including the service dataset and the condition set).

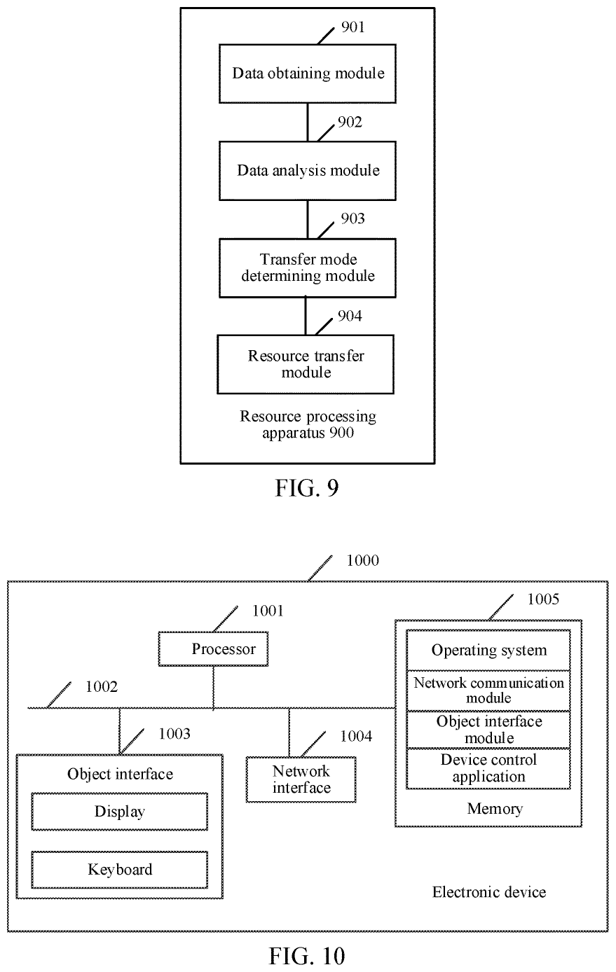

Referring to FIG. 9, FIG. 9 is a schematic diagram of a structure of a resource processing apparatus 900 according to one or more embodiments. The resource processing apparatus 900 includes:
a data obtaining module 901, configured to obtain a first service dataset from a preset dataset, the first service dataset including at least one piece of service data, and each piece of service data being configured for recording a first historical resource transfer amount of a first resource type and a second historical resource transfer amount of a second resource type when resources are transferred between the first resource type and the second resource type;
a data analysis module 902, configured to determine, based on the second historical resource transfer amount, target service data that is in the at least one piece of service data and that meets a resource transfer condition;
a transfer mode determining module 903, configured to determine a first resource transfer mode of the first resource type based on the first historical resource transfer amount and the second historical resource transfer amount, the first resource transfer mode including resource transfer-in or resource transfer-out; and
a resource transfer module 904, configured to transfer resources of the first historical resource transfer amount of the first resource type based on the first resource transfer mode.

In some embodiments, the data analysis module 902 is configured to:
obtain a first condition set associated with the first service dataset, the first condition set including at least one trigger condition, and each trigger condition including a resource quantity threshold;
determine, in the at least one piece of service data, at least one piece of candidate service data in which second historical resource transfer amount exceeds at least one of the resource quantity thresholds; and
determine the target service data based on the at least one piece of candidate service data.

In some embodiments, each trigger condition further includes a resource type range and a valid time interval. The data analysis module 902 is configured to:
for each piece of candidate service data,
determine, in the at least one trigger condition, a trigger condition in which the resource quantity threshold does not exceed the second historical resource transfer amount in the candidate service data as a candidate trigger condition; and
determine the candidate service data as the target service data in response to a current moment being within the valid time interval included in any candidate trigger condition, and the resource type range included in the any candidate trigger condition including the first resource type in the candidate service data.

In some embodiments, each piece of service data is configured for recording a first historical resource transfer-in amount of the first resource type and a second historical resource transfer-out amount of the second resource type, or is configured for recording a first historical resource transfer-out amount of the first resource type and a second historical resource transfer-in amount of the second resource type.

In some embodiments, the transfer mode determining module 903 is configured to:
determine the first resource transfer mode as the resource transfer-in in response to the first historical resource transfer amount being the first historical resource transfer-out amount, and the second historical resource transfer amount being the second historical resource transfer-in amount; and
determine the first resource transfer mode as the resource transfer-out in response to the first historical resource transfer amount being the first historical resource transfer-in amount, and the second historical resource transfer amount being the second historical resource transfer-out amount.

In some embodiments, the preset dataset includes at least one service dataset and a condition set associated with each service dataset. A resource pool includes at least one resource entry, where each resource entry includes a dataset identifier corresponding to a service dataset in the preset dataset and a condition set identifier corresponding to a condition set associated with the service dataset. The data obtaining module 901 is further configured to:
obtain a resource entry in an unlocked state from the resource pool as a target resource entry, and set the target resource entry to be in a locked state;
determine a service dataset that is in the preset dataset and that corresponds to the dataset identifier in the target resource entry as the first service dataset; and
determine a condition set that is in the preset dataset and that corresponds to the condition set identifier in the target resource entry as the first condition set.

In some embodiments, the resource transfer module 904 is further configured to: set the target resource entry to be in the unlocked state in response to completing the resource transfer of the first historical resource transfer amount based on the first resource transfer mode.

In some embodiments, the resource transfer module 904 is further configured to: terminate the resource transfer in response to the resource transfer of the first historical resource transfer amount being not completed based on the first resource transfer mode within a preset duration after the target resource entry is set to be in the locked state, and set the target resource entry to be in the unlocked state.

In some embodiments, the resource transfer module 904 is configured to: transfer resources of the first historical resource transfer-out amount of the first resource type into a virtual account corresponding to the first resource type when the first resource transfer mode is the resource transfer-in; and
transfer resources of the first historical resource transfer-in amount of the first resource type out of a virtual account corresponding to the first resource type when the first resource transfer mode is the resource transfer-out.

In some embodiments, the resource transfer module 904 is configured to:
determine a resource conversion rate between the first resource type and the second resource type;
determine a current resource transfer amount corresponding to the second resource type based on the first historical resource transfer amount and the resource conversion rate;
transfer the resources of the first historical resource transfer amount of the first resource type based on the first resource transfer mode; and
transfer resources of the current resource transfer amount of the second resource type based on a second resource transfer mode, the first resource transfer mode being opposite to the second resource transfer mode.

In some embodiments, the data obtaining module 901 is further configured to:
for service data in each service dataset of the preset dataset,
generate a condition set associated with the service dataset;
generate a resource entry of the service dataset based on the dataset identifier of the service dataset and the condition set identifier of the generated condition set; and
add each resource entry to the resource pool, and set each resource entry to be in the unlocked state.

In some embodiments, the data obtaining module 901 is further configured to:
obtain a plurality of pieces of service data; and
classify the plurality of pieces of service data based on at least one of a generation time of the first historical resource transfer amount, a generation time of the second historical resource transfer amount, the first resource type, the second resource type, and a source of the service data, to obtain the at least one service dataset.

During specific implementation, the foregoing resource processing apparatus may perform the implementations provided by the operations in FIG. 2 through the functional modules built in the resource processing apparatus. For details, refer to the implementations provided by the foregoing operations. Details are not described herein again.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module and unit are executable by a processor to thereby cause the processor to perform the respective operations of the corresponding module.

Referring to FIG. 10, FIG. 10 is a schematic diagram of a structure of an electronic device according to one or more embodiments. As shown in FIG. 10, the electronic device 1000 in this embodiment may include: a processor 1001, a network interface 1004, and a memory 1005. In addition, the foregoing electronic device 1000 may further include: an object interface 1003, and at least one communication bus 1002. The communication bus 1002 is configured to implement communication between these components. The object interface 1003 may include a display and a keyboard. In some embodiments, the object interface 1003 may further include a standard wired interface and a standard wireless interface. In some embodiments, the network interface 1004 may include a standard wired interface and a standard wireless interface (for example, a wireless fidelity (Wi-Fi) interface). The memory 1005 may be a high-speed random access memory (RAM), or may be a non-volatile memory (NVM), for example, at least one magnetic disk memory. In some embodiments, the memory 1005 may be at least one storage apparatus that is located far away from the foregoing processor 1001. As shown in FIG. 10, the memory 1005, which is used as a computer-readable storage medium, may include an operating system, a network communication module, an object interface module, and a device control application.

In the electronic device 1000 shown in FIG. 10, the network interface 1004 may provide a network communication function. The object interface 1003 is mainly configured to provide an input interface for an object. The processor 1001 may be configured to invoke the device control application stored in the memory 1005, to implement the operations in the foregoing embodiments.

In some embodiments, the processor 1001 may be a central processing unit (CPU), and the processor may be another general-purpose processor, a digital signal processor (DSP), an application-specific integrated circuit (ASIC), a field-programmable gate array (FPGA) or another programmable logic device, a discrete gate, a transistor logic device, a discrete hardware component, or the like. The general-purpose processor may be a microprocessor or the processor may be any conventional processor. The memory may include a read-only memory and a random access memory, and provide instructions and data for the processor. A part of the memory may further include a non-volatile random access memory. For example, the memory may further store device type information.

During specific implementation, the foregoing electronic device 1000 may perform the implementations provided by the operations in FIG. 2 through the functional modules built in the electronic device 1000. For details, refer to the implementations provided by the foregoing operations. Details are not described herein again.

Some embodiments further provide a computer-readable storage medium. The computer-readable storage medium stores a computer program, and the computer program is executed by a processor to implement the method provided in the operations in FIG. 2. For details, refer to the implementations provided by the foregoing operations. Details are not described herein again.

The computer-readable storage medium may be an internal storage unit of the resource processing apparatus or the electronic device according to any one of the foregoing embodiments, such as a hard disk or internal memory of the electronic device. The computer-readable storage medium may be an external storage device of the electronic device, such as a plug-in hard disk, a smart media card (SMC), a secure digital (SD) card, or a flash card that is equipped on the electronic device. The computer-readable storage medium may further include a magnetic disk, an optical disc, a read-only memory (ROM), a random access memory (RAM), or the like. Further, the computer-readable storage medium may include both an internal storage unit and an external storage device of the electronic device. The computer-readable storage medium is configured to store the computer program and another program and data required by the electronic device. The computer-readable storage medium may be further configured to temporarily store data that has been or is to be outputted.

Some embodiments provide a computer program product, including a computer program. When the computer program is executed by a processor, the method provided in the operations in FIG. 2 is performed.

In the claims, specification, and accompanying drawings of the disclosure, the terms “first”, “second”, and the like are intended to distinguish between different objects but do not indicate a specific order. Besides, the terms “include”, “have”, and any variations thereof are intended to cover a non-exclusive inclusion. For example, a process, a method, a system, a product, or an electronic device including a series of operations or units is not limited to the listed operations or units, but instead, in some embodiments, includes operations or units that are not listed, or in some embodiments, includes other operations or units inherent to the process, method, product, or electronic device. The “embodiment” mentioned herein means that specific features, structures, or characteristics described with reference to the embodiment may be included in at least one embodiment. The term presented at various positions in the specification may not necessarily refer to the same embodiment, and is not an independent or alternative embodiment exclusive from another embodiment. A person skilled in the art explicitly or implicitly understands that the embodiments described herein may be combined with other embodiments. The term “and/or” used in the specification and the appended claims of the disclosure refers to any and all possible combinations of one or more of associated listed items, and includes these combinations.

A person of ordinary skill in the art may be aware that the units and algorithm operations in the examples described with reference to the embodiments disclosed herein may be implemented by electronic hardware, computer software, or a combination thereof. To clearly describe the interchangeability between the hardware and the software, the foregoing has generally described compositions and operations of each example according to functions.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A resource processing method, performed by an electronic device, comprising:
obtaining a first service dataset from a preset dataset, the first service dataset comprising at least one piece of service data, and each piece of service data being configured for recording a first historical resource transfer amount of a first resource type and a second historical resource transfer amount of a second resource type based on resources being transferred between the first resource type and the second resource type;
determining, based on the second historical resource transfer amount, target service data that is in the at least one piece of service data and that meets a resource transfer condition;
determining a first resource transfer mode of the first resource type based on the first historical resource transfer amount and the second historical resource transfer amount in the target service data, the first resource transfer mode comprising resource transfer-in or resource transfer-out; and
transferring resources of the first historical resource transfer amount of the first resource type based on the first resource transfer mode.

2. The resource processing method according to claim 1, wherein the determining, based on the second historical resource transfer amount, the target service data that is in the at least one piece of service data and that meets a resource transfer condition comprises:
obtaining a first condition set associated with the first service dataset, the first condition set comprising at least one trigger condition, and each trigger condition comprising a resource quantity threshold;
determining, in the at least one piece of service data, at least one piece of candidate service data in which the second historical resource transfer amount exceeds at least one of the resource quantity thresholds; and
determining the target service data based on the at least one piece of candidate service data.

3. The resource processing method according to claim 2, wherein each trigger condition further comprises a resource type range and a valid time interval; and
wherein the determining the target service data based on the at least one piece of candidate service data comprises:
for each piece of candidate service data,
determining, in the at least one trigger condition, a trigger condition in which the resource quantity threshold does not exceed the second historical resource transfer amount in the candidate service data as a candidate trigger condition; and
determining the candidate service data as the target service data based on a current moment being within the valid time interval comprised in any candidate trigger condition, and the resource type range comprised in the any candidate trigger condition comprising the first resource type in the candidate service data.

4. The resource processing method according to claim 1, wherein each piece of the at least one piece of service data is configured for recording a first historical resource transfer-in amount of the first resource type and a second historical resource transfer-out amount of the second resource type, or is configured for recording a first historical resource transfer-out amount of the first resource type and a second historical resource transfer-in amount of the second resource type.

5. The resource processing method according to claim 4, wherein the determining the first resource transfer mode of the first resource type based on the first historical resource transfer amount and the second historical resource transfer amount comprises:
determining the first resource transfer mode as the resource transfer-in based on the first historical resource transfer amount being the first historical resource transfer-out amount, and the second historical resource transfer amount being the second historical resource transfer-in amount; and
determining the first resource transfer mode as the resource transfer-out based on the first historical resource transfer amount being the first historical resource transfer-in amount, and the second historical resource transfer amount being the second historical resource transfer-out amount.

6. The resource processing method according to claim 2, wherein the preset dataset comprises at least one service dataset and a condition set associated with each of the at least one service dataset, a resource pool comprises at least one resource entry, each resource entry comprising a dataset identifier corresponding to one service dataset in the preset dataset, and a condition set identifier corresponding to the condition set associated with the service dataset, and
wherein the resource processing method further comprises:
obtaining a resource entry in an unlocked state from the resource pool as a target resource entry, and setting the target resource entry to be in a locked state;
the obtaining the first service dataset from the preset dataset comprises:
determining a service dataset that is in the preset dataset and that corresponds to the dataset identifier in the target resource entry as the first service dataset; and
the obtaining the first condition set associated with the first service dataset comprises:
determining a condition set that is in the preset dataset and that corresponds to the condition set identifier in the target resource entry as the first condition set.

7. The resource processing method according to claim 6, further comprising:
setting the target resource entry to be in the unlocked state based on the resource transfer of the first historical resource transfer amount being completed based on the first resource transfer mode.

8. The resource processing method according to claim 6, further comprising:
terminating the resource transfer in response to the resource transfer of the first historical resource transfer amount being not completed based on the first resource transfer mode within a preset duration after the target resource entry is set to be in the locked state, and setting the target resource entry to be in the unlocked state.

9. The resource processing method according to claim 4, wherein the transferring resources of the first historical resource transfer amount of the first resource type based on the first resource transfer mode comprises:
transferring resources of the first historical resource transfer-out amount of the first resource type into a virtual account corresponding to the first resource type based on the first resource transfer mode being the resource transfer-in; and
transferring resources of the first historical resource transfer-in amount of the first resource type out of a virtual account corresponding to the first resource type based on the first resource transfer mode being the resource transfer-out.

10. The resource processing method according to claim 1, wherein the transferring resources of the first historical resource transfer amount of the first resource type based on the first resource transfer mode comprises:
determining a resource conversion rate between the first resource type and the second resource type;
determining a current resource transfer amount corresponding to the second resource type based on the first historical resource transfer amount and the resource conversion rate;
transferring the resources of the first historical resource transfer amount of the first resource type based on the first resource transfer mode; and
transferring resources of the current resource transfer amount of the second resource type based on a second resource transfer mode, the first resource transfer mode being opposite to the second resource transfer mode.

11. The resource processing method according to claim 6, further comprising:
for service data in each service dataset of the preset dataset,
generating a condition set associated with the service dataset;
generating a resource entry of the service dataset based on the dataset identifier of the service dataset and the condition set identifier of the generated condition set; and
adding each resource entry to the resource pool, and setting each resource entry to be in the unlocked state.

12. The resource processing method according to claim 1, wherein the at least one service dataset is determined based on the following manner:
obtaining a plurality of pieces of service data; and
classifying the plurality of pieces of service data based on at least one of a generation time of the first historical resource transfer amount, a generation time of the second historical resource transfer amount, the first resource type, the second resource type, and a source of the service data, to obtain the at least one service dataset.

13. A resource processing apparatus, comprising:
at least one memory configured to store computer program code; and
at least one processor configured to read the program code and operate as instructed by the program code, the program code comprising:
data obtaining code configured to cause at least one of the at least one processor to obtain a first service dataset from a preset dataset, the first service dataset comprising at least one piece of service data, and each piece of service data being configured for recording a first historical resource transfer amount of a first resource type and a second historical resource transfer amount of a second resource type based on resources being transferred between the first resource type and the second resource type;
data analysis code configured to cause at least one of the at least one processor to determine, based on the second historical resource transfer amount, target service data that is in the at least one piece of service data and that meets a resource transfer condition;
transfer mode determining code configured to cause at least one of the at least one processor to determine a first resource transfer mode of the first resource type based on the first historical resource transfer amount and the second historical resource transfer amount in the target service device, the first resource transfer mode comprising resource transfer-in or resource transfer-out; and
resource transfer code configured to cause at least one of the at least one processor to transfer resources of the first historical resource transfer amount of the first resource type based on the first resource transfer mode.

14. The resource processing apparatus according to claim 13, wherein the data analysis code is configured to cause at least one of the at least one processor to:
obtain a first condition set associated with the first service dataset, the first condition set comprising at least one trigger condition, and each trigger condition comprising a resource quantity threshold;
determine, in the at least one piece of service data, at least one piece of candidate service data in which the second historical resource transfer amount exceeds at least one of the resource quantity thresholds; and
determine the target service data based on the at least one piece of candidate service data.

15. The resource processing apparatus according to claim 13, wherein each piece of service data is configured for recording a first historical resource transfer-in amount of the first resource type and a second historical resource transfer-out amount of the second resource type, or is configured for recording a first historical resource transfer-out amount of the first resource type and a second historical resource transfer-in amount of the second resource type.

16. The resource processing apparatus according to claim 15, wherein the transfer mode determining code is configured to cause at least one of the at least one processor to:
determine the first resource transfer mode as the resource transfer-in based on the first historical resource transfer amount being the first historical resource transfer-out amount, and the second historical resource transfer amount being the second historical resource transfer-in amount; and
determine the first resource transfer mode as the resource transfer-out based on the first historical resource transfer amount being the first historical resource transfer-in amount, and the second historical resource transfer amount being the second historical resource transfer-out amount.

17. The resource processing apparatus according to claim 15, wherein the resource transfer code is configured to cause at least one of the at least one processor to:
transfer resources of the first historical resource transfer-out amount of the first resource type into a virtual account corresponding to the first resource type based on the first resource transfer mode being the resource transfer-in; and
transfer resources of the first historical resource transfer-in amount of the first resource type out of a virtual account corresponding to the first resource type based on the first resource transfer mode being the resource transfer-out.

18. A non-transitory computer-readable storage medium, storing computer code which, when executed by at least one processor, causes the at least one processor to at least:
obtain a first service dataset from a preset dataset, the first service dataset comprising at least one piece of service data, and each piece of service data being configured for recording a first historical resource transfer amount of a first resource type and a second historical resource transfer amount of a second resource type based on resources being transferred between the first resource type and the second resource type;
determine, based on the second historical resource transfer amount, target service data that is in the at least one piece of service data and that meets a resource transfer condition;
determine a first resource transfer mode of the first resource type based on the first historical resource transfer amount and the second historical resource transfer amount in the target service data, the first resource transfer mode comprising resource transfer-in or resource transfer-out; and
transfer resources of the first historical resource transfer amount of the first resource type based on the first resource transfer mode.

19. The non-transitory computer-readable storage medium according to claim 18, wherein the determine, based on the second historical resource transfer amount, the target service data that is in the at least one piece of service data and that meets a resource transfer condition comprises:
obtaining a first condition set associated with the first service dataset, the first condition set comprising at least one trigger condition, and each trigger condition comprising a resource quantity threshold;
determining, in the at least one piece of service data, at least one piece of candidate service data in which the second historical resource transfer amount exceeds at least one of the resource quantity thresholds; and
determining the target service data based on the at least one piece of candidate service data.

20. The non-transitory computer-readable storage medium according to claim 19, wherein each trigger condition further comprises a resource type range and a valid time interval; and
wherein the determine the target service data based on the at least one piece of candidate service data comprises:
for each piece of candidate service data,
determining, in the at least one trigger condition, a trigger condition in which the resource quantity threshold does not exceed the second historical resource transfer amount in the candidate service data as a candidate trigger condition; and
determining the candidate service data as the target service data based on a current moment being within the valid time interval comprised in any candidate trigger condition, and the resource type range comprised in the any candidate trigger condition comprising the first resource type in the candidate service data.
